(19) United States
(12) Patent Application Publication
(10) Pub. No.: US 2018/0200761 A1
(43) Pub. Date: Jul. 19, 2018

(54) SYSTEMS AND METHODS FOR OPTIMIZING THE LOADING OF MERCHANDISE AT MERCHANDISE DISTRIBUTION CENTERS

(71) Applicant: Wal-Mart Stores, Inc., Bentonville, AR (US)

(72) Inventors: Sai Phaneendra Sri Harsha Viswanath Putcha, Bentonville, AR (US); Ryan Lee, Bentonville, AR (US)

(21) Appl. No.: 15/872,137

(22) Filed: Jan. 16, 2018

Related U.S. Application Data
(60) Provisional application No. 62/447,969, filed on Jan. 19, 2017.

(51) Int. Cl. B07C 3/18; G06Q 50/28; B65G 67/08; G06K 7/10

(52) U.S. Cl. CPC B07C 3/18; G06Q 50/28; G06Q 10/04; G06K 7/10366; B65G 67/08

(57) ABSTRACT

In some embodiments, apparatuses and methods are provided herein useful to end-to-end optimization for the loading of delivery vehicles with merchandise items at merchandise distribution centers. In some embodiments, there is provided a system including: merchandise items; a merchandise distribution center; conveyor assemblies extending from a merchandise storage area to a merchandise loading area, loading mechanism(s) in the merchandise loading area for assisting in the transport of merchandise items from conveyor assemblies to delivery vehicles; and a central computing system configured to: receive a first signal regarding each merchandise item; receive a second signal regarding the loading space of the delivery vehicle; determine the arrival of merchandise items in the loading area; coordinate the transport of merchandise items from conveyor assemblies to the loading space using the loading mechanism(s); and determine an arrangement and instruct a sequence of loading of the merchandise items in the loading space.

### CROSS-REFERENCE TO RELATED APPLICATION

This application claims the benefit of U.S. Provisional Application No. 62/447,969, filed Jan. 19, 2017, which is incorporated by reference in its entirety herein.

### TECHNICAL FIELD

This invention relates generally to loading merchandise at merchandise distribution centers, and more particularly, to the end-to-end optimization of the loading of delivery vehicles with merchandise items at merchandise distribution centers.

### BACKGROUND

In the retail setting, one important challenge is optimizing the handling of merchandise at merchandise distribution centers. Generally, merchandise items of various shapes and sizes must be transported from a storage area to a loading area and onto a delivery vehicle. Delivery vehicles may then transport the loaded merchandise to the retailer's stores or directly to customers. When merchandise is not handled and loaded onto delivery vehicles in an efficient manner, this inefficiency may result in delays in the departure of delivery vehicles and in additional and unnecessary delivery trips.

It is desirable to develop an end-to-end approach that optimizes the loading of merchandise at distribution centers. It is desirable to develop an efficient approach for transporting merchandise from the storage area, along conveyor assemblies, from the conveyor assemblies to the delivery vehicles, and into the loading space of the delivery vehicles. It is desirable to optimize this entire transport process at the merchandise distribution center.

### BRIEF DESCRIPTION OF THE DRAWINGS

Disclosed herein are embodiments of systems, apparatuses and methods pertaining to the end-to-end optimization of the loading of delivery vehicles at merchandise distribution centers. This description includes drawings, wherein:

FIG. 1 is a schematic representation in accordance with some embodiments;

FIG. 2 is a block diagram in accordance with some embodiments;

FIG. 3 is a flow diagram in accordance with some embodiments; and

FIG. 4 is a block diagram in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful to the end-to-end optimization of the loading of delivery vehicles with merchandise items at merchandise distribution centers. In one form, the system includes: a plurality of merchandise items of various weights, volumes, shapes, and sizes; a merchandise distribution center including a merchandise storage area and a merchandise loading area; a plurality of conveyor assemblies extending from the merchandise storage area to the merchandise loading area, the plurality of conveyor assemblies configured to transport the plurality of merchandise items from the merchandise storage area to the merchandise loading area; at least one loading mechanism in the merchandise loading area configured to assist in transport of at least one merchandise item from at least one conveyor assembly to a delivery vehicle with an interior defining a loading space; and a central computing system operatively coupled to the plurality of conveyor assemblies, the central computing system configured to: receive a first signal regarding characteristics of each merchandise item; receive a second signal regarding characteristics of the loading space; determine the arrival of the plurality of merchandise items on the plurality of conveyor assemblies in the merchandise loading area; coordinate the transport of at least one subset of merchandise items from the at least one conveyor assembly to the loading space using the at least one loading mechanism; and determine a first arrangement and instruct a sequence of loading of the plurality of merchandise items in the loading space; wherein the first arrangement is designed to fit the plurality of merchandise items in the loading space in a manner such that insufficient volume of the loading space is available for loading additional merchandise items.

In one form, in the system, the first signal may include data regarding at least one of weight, volume, dimensions, stability, fragility, whether the merchandise item is to be carried on a pallet, the boxed or unboxed nature of the merchandise item, and the perishable nature of the merchandise. Further, the second signal may include data regarding at least one of dimensions, weight distribution, or capacity of the loading space. In addition, the at least one loading mechanism may include at least one of a robot or robot arm, automated guided vehicles, voice commands, speech recognition, networked interactive eyewear, laser guidance, a computer designed loading map, and RFID tags.

In one form, the central computing system may be configured to instruct manual delivery of a merchandise item from the loading area to the loading space based, at least in part, on the first signal regarding characteristics of the merchandise item. Also, the central computing system may be configured to: receive a third signal regarding the spatial arrangement of the plurality of conveyor assemblies in the merchandise loading area; and determine the first arrangement and sequence of loading of the plurality of merchandise items in the loading space based, at least in part, on the spatial arrangement of the plurality of conveyor assemblies in the merchandise loading area. Further, the central computing system may be configured to: receive a fourth signal regarding the number and order of delivery destinations of the delivery vehicle; and determine the first arrangement and sequence of loading of the plurality of merchandise items in the loading space based, at least in part, on the number and order of delivery destinations of the delivery vehicle. In addition, the central computing system may be configured to: receive a fifth signal regarding the scheduled time of departure of the delivery vehicle; and determine a number of individuals required for loading the plurality of merchandise items in the loading space by the scheduled time of departure of the delivery vehicle.

In one form, the central computing system may be configured to: receive a sixth signal comprising feedback information regarding prior deliveries; and adjust the determination of the first arrangement and the instruction of the sequence of loading of the plurality of merchandise items based, at least in part, on the feedback information. Also, the central computing system may be configured to: determine the loading sequence prior to removal of the plurality of merchandise items from the plurality of conveyor assemblies; and instruct a predetermined number of individuals to load the loading space in accordance with the loading sequence. In addition, the system for end-to-end optimization may further include at least one photo sensor mounted to each conveyor assembly and communicatively coupled to the central computing system, the at least one photo sensor configured to detect the plurality of merchandise items.

In another form, there is provided a method for loading delivery vehicles with merchandise items from merchandise distribution centers, the method including: providing a plurality of merchandise items of various weights, volumes, shapes, and sizes; providing a merchandise distribution center including a merchandise storage area and a merchandise loading area; providing a plurality of conveyor assemblies extending from the merchandise storage area to the merchandise loading area, the plurality of conveyor assemblies configured to transport the plurality of merchandise items from the merchandise storage area to the merchandise loading area; providing at least one loading mechanism in the merchandise loading area configured to assist in transport of at least one merchandise item from at least one conveyor assembly to a delivery vehicle with an interior defining a loading space; receiving a first signal regarding characteristics of each merchandise item; receiving a second signal regarding characteristics of the loading space; determining the arrival of the plurality of merchandise items on the plurality of conveyor assemblies in the merchandise loading area; coordinating the transport of at least one subset of merchandise items from the at least one conveyor assembly to the loading space using the at least one loading mechanism; determining a first arrangement of the plurality of merchandise items in the loading space; and instructing a sequence of loading of the plurality of merchandise items in the loading space; wherein the first arrangement is designed to fit the plurality of merchandise items in the loading space in a manner such that insufficient volume of the loading space is available for loading additional merchandise items.

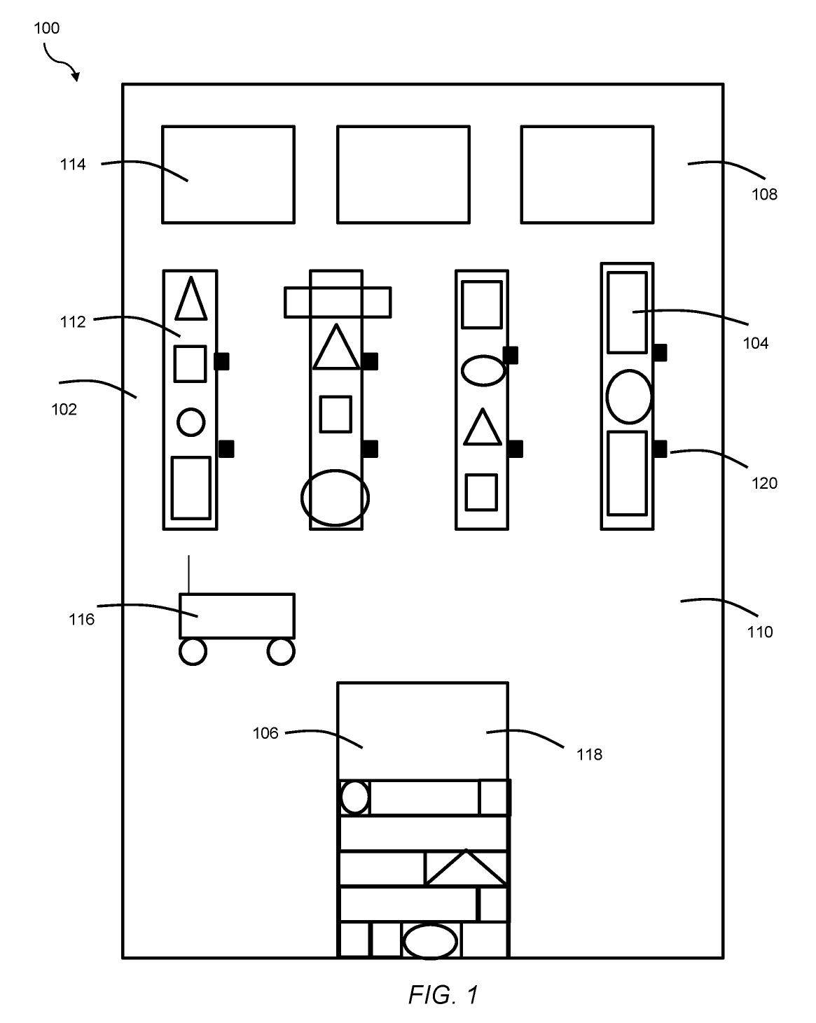

Referring to FIG. 1, there is shown a system 100 for optimizing how merchandise is loaded onto delivery vehicles at merchandise distribution centers. Generally, it is intended to optimize the loading at each stage of movement of merchandise items from a storage area, to transport to a loading area, to movement onto a delivery vehicle, and into a predetermined loading space on the delivery vehicle. Further, by taking into account various inputs in addition to these various stages, the loading of delivery vehicles can be optimized.

FIG. 1 is a schematic representation of a merchandise/product distribution center 102. In one form, it is generally contemplated that the distribution center 102 operated by a retailer that will store a variety of merchandise items 104 that may be transported to various retail stores. In addition or alternatively, the distribution center 102 may be an e-commerce facility that allows the transport of merchandise items 104 directly to customers or to third party delivery service providers that, in turn, may transport the merchandise items 104 to customers. In other words, the distribution center 102 is generally intended for storage of merchandise items 104 that may be transported by delivery vehicles 106 to various destinations. FIG. 1 shows a part of a delivery vehicle 106 where the merchandise items 104 are loaded, i.e., the trailer of a delivery truck.

As can be seen in FIG. 1, the merchandise distribution center 102 includes a merchandise storage area 108 and a merchandise loading area 110. In one form, it is contemplated that the merchandise storage area 108 generally includes the locations of the distribution center 102 where the merchandise items 104 are stored prior to transport. As should be understood, this storage may be in accordance with any of various storage packing plans or arrangements. In one form, the merchandise loading area 110 is generally contemplated as the area in the distribution center 102 where the merchandise items 104 are ultimately moved onto the delivery vehicle 106. This loading area 110 may include one or more loading docks configured to receive the delivery vehicles 106. Various parts of the loading area 110 may be in the same physical building as the storage area 108, in an area adjacent to the storage area 108, and/or in separate physical buildings.

The system 100 includes conveyor assemblies 112 that extend from the merchandise storage area 108 to the merchandise loading area 110. As can be seen, the conveyor assemblies 112 are configured to transport merchandise items 104 from the storage area 108 to the loading area 110. It is contemplated that the merchandise items 104 will be of various weights, volumes, shapes, and sizes. The conveyor assemblies 112 may be of various conventional types and have various physical structures. Further, they may be arranged in various ways to accommodate the physical structure of the distribution center 102 and to provide routes from specific merchandise storage locations 114 in the storage area 108 to the loading area 110. In one form, as one example, the merchandise storage locations 114 may be in the form of dense storage units where each individual storage location has unique coordinates and is assigned to store a specific type of merchandise item 104.

The system 100 also includes loading mechanism(s) 116 in the merchandise loading area 110 configured to assist in the transport of merchandise item(s) 104 from the conveyor assemblies 112 to the delivery vehicle 106. In one form, as shown in FIG. 1, the loading mechanism 116 may be a robotic vehicle that retrieves merchandise items 104 and navigates from the conveyor assemblies 112 to the delivery vehicle 106. However, as addressed further below, it is generally contemplated that the system 100 may use a number and variety of different loading mechanisms 116. As can be seen in FIG. 1, the delivery vehicle 106 has an interior defining a loading space 118 that is partially loaded with merchandise items 104 of various sizes and shapes. As described further below, in one aspect, the system 100 optimizes the use of the loading space 118 in the delivery vehicle 106.

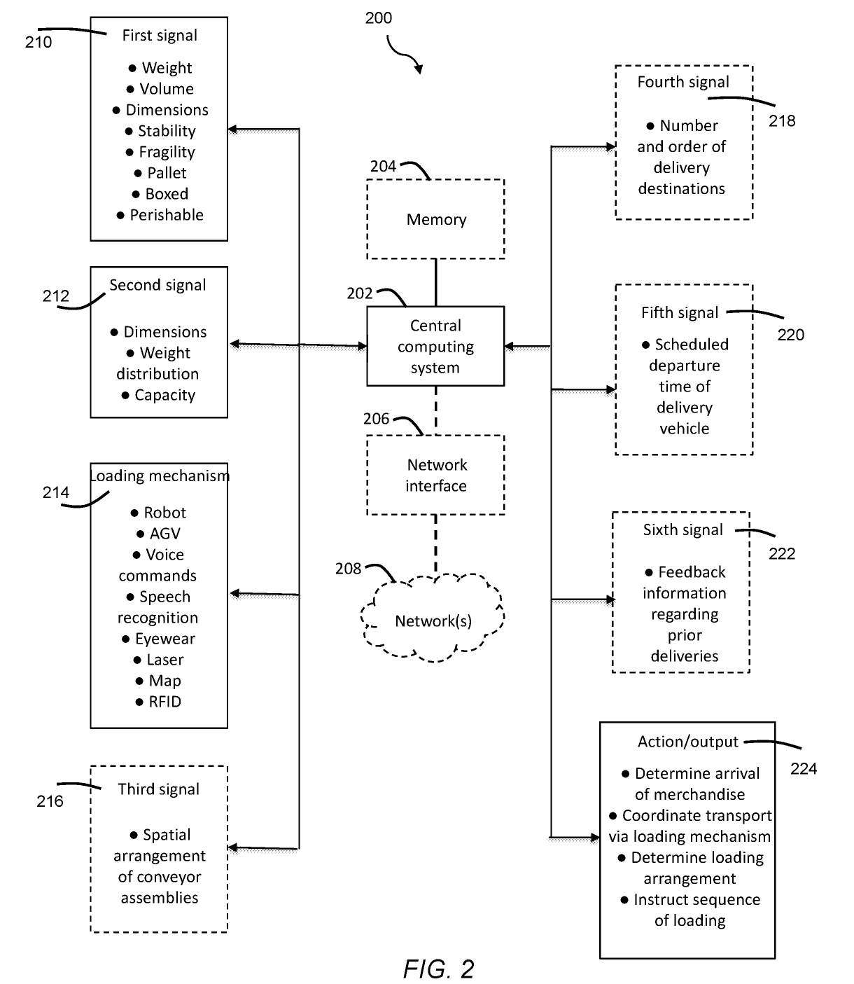

Referring to FIG. 2, the system 200 uses various inputs and signals to optimize the loading of the delivery vehicle 106. The system 200 uses some or all of the components of the system 100 described above. The system 200 generally uses inputs regarding characteristics of the merchandise items 104 being loaded, characteristics regarding the loading space 118 of the delivery vehicle 106, the nature and type of loading mechanisms 116, the arrangement of the conveyor assemblies 112, the delivery destinations, the departure time of the delivery vehicle 106, and/or feedback information from prior deliveries. The system 100 uses some or all of these inputs to determine a loading arrangement and sequence of loading.

The system 200 includes a central computing system 202 that receives the various inputs and signals and that determines the loading arrangement and sequence of loading. The system 200 includes a central computing system 202 that may be communicatively coupled to several databases, as addressed further below. The central computing system 202 comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the central computing system 202 to effect the control aspect of these teachings.

Such a central computing system 202 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This central computing system 202 is configured (for example, by using corresponding programming as will be well understood by those skilled in the art) to carry out one or more of the steps, actions, and/or functions described herein.

By one optional approach, the central computing system 202 operably couples to a memory 204. This memory 204 may be integral to the central computing system 202 or can be physically discrete (in whole or in part) from the central computing system 202, as desired. This memory 204 can also be local with respect to the central computing system 202 (where, for example, both share a common circuit board, chassis, power supply, and/or housing) or can be partially or wholly remote with respect to the central computing system 202 (where, for example, the memory 204 is physically located in another facility, metropolitan area, or even country as compared to the central computing system 202).

This memory 204 can serve, for example, to non-transitorily store the computer instructions that, when executed by the central computing system 202, cause the central computing system 202 to behave as described herein. As used herein, this reference to “non-transitorily” will be understood to refer to a non-ephemeral state for the stored contents (and hence excludes when the stored contents merely constitute signals or waves), rather than volatility of the storage media itself, and hence includes both non-volatile memory (such as read-only memory (ROM)) as well as volatile memory (such as an erasable programmable read-only memory (EPROM).)

In this example, the central computing system 202 may also be operatively coupled to a network interface 206. So configured, the central computing system 202 can communicate with other elements (both within the system 200 and external thereto) via the network interface 206. Network interfaces, including both wireless and non-wireless platforms, are well understood in the art and require no particular elaboration here. This network interface 206 can compatibly communicate via whatever network or networks 208 may be appropriate to suit the particular needs of a given application setting. Both communication networks and network interfaces are well understood areas of prior art endeavor and therefore no further elaboration will be provided here in those regards for the sake of brevity.

The central computing system 202 is configured to receive a first signal 210 regarding characteristics of each merchandise item 104. These characteristics may include data regarding weight, volume, dimensions, stability, fragility, whether the merchandise item 104 is to be carried on a pallet, the boxed or unboxed nature of the merchandise item 104, and the perishable nature of the merchandise 104. It is generally contemplated that the central computing system 202 uses some or all of these characteristics in determining, in part, the loading arrangement and sequence in the loading space 118. The central computing system 202 may also consider the type of merchandise item 104, i.e., general merchandise, grocery, dairy, etc. It may be desirable to group some types of merchandise items 104 together in the loading space 118 while keeping other types separate.

The central computing system 202 may receive this first signal 210 from a variety of sensors and/or databases. For example, in one form, it is contemplated that each conveyor assembly 112 may include a reader or scanner (such as a barcode or RFID tag reader) that can read a product identifier on each merchandise item 104 (such as a barcode or RFID tag). This product identifier may be transmitted to the central computing system 202, which can look up characteristics of the scanned merchandise item 104 in a product identifier database. The database may include some or all of the characteristics identified above: weight, volume, dimensions, stability, fragility, pallet or boxed nature, and perishability.

In another form, it is contemplated that the distribution center 102 may include sensor(s) at or before the conveyor assemblies 112. For instance, the distribution center 102 may include weight, pressure, image capture, or other sensors prior to placing the merchandise items 104 on the conveyor assemblies 112. Alternatively, the conveyor assemblies 112 themselves may include such sensors incorporated into their structure or mounted on them. Such sensors at the conveyor assemblies 112 may be used to measure and transmit some of the characteristics of the merchandise items 104 to the central computing system 202.

The central computing system 202 is configured to receive a second signal 212 regarding characteristics of the loading space 118. These characteristics may include data regarding dimensions, weight distribution, and/or capacity of the loading space 118. The central computing system 202 uses these characteristics in determining, in part, the loading arrangement and sequence in the loading space 118.

The central computing system 202 may also receive this second signal 212 from a variety of sensors and/or databases. For example, in one form, it is contemplated that the delivery vehicle 106 will include a vehicle identifier that may be inputted manually or by a scanner/reader and then transmitted to the central computing system 202. In this form, it is contemplated that the central computing system 202 may look up the characteristics of the delivery vehicle 106 in a delivery vehicle database. The database may include some or all of the characteristics identified above: dimensions of the loading space 118, weight distribution in the loading space 118 (all of the merchandise weight should not be assigned to one side of the delivery vehicle 106), and/or storage capacity/volume of the loading space 118.

In another form, it is contemplated that sensors may be used to collect and transmit data regarding the characteristics of the loading space 118. For instance, the sensors may include image capture sensors (such as cameras and/or video devices) that may capture image sequences of the loading space 118. These image sequences may be transmitted to the central computing system 202, which may then generate estimates of the loading space dimensions and/or capacity of the loading space 118 from the image sequences.

The central computing system 202 determines the arrival of the merchandise items 104 on the conveyor assemblies 112 in the merchandise loading area 110. In one form, sensors 120 (such as photo sensors) may be mounted on the conveyor assemblies 112 for detecting the merchandise items 104. In other words, sensor(s) 120 (such as photo sensor(s)) may be mounted to each conveyor assembly 112 and communicatively coupled to the central computing system 202 with the sensor(s) configured to detect the arrival of merchandise items 104 and their location, i.e., the conveyor assembly 112 corresponding to the detected merchandise item 104. It is generally contemplated that the central computing system 202 may use this information regarding arrival and location of merchandise items 104 to coordinate their transport to the loading space 118 and their arrangement and sequence of loading within the loading space 118. In one form, it is contemplated that the sensor(s) 120 for detecting arrival and location of merchandise items 104 may be structurally combined with the sensor(s) for detecting characteristics of the merchandise items 104, as described above. However, separate sensor(s) may also be used. Further, as can be seen in FIG. 1, in one form, more than one sensor 120 may be mounted on the conveyor assemblies 112 and may be spaced at certain intervals along the conveyor assemblies 112.

The central computing system 202 coordinates the transport of merchandise items 104 from the conveyor assembly(ies) 112 to the loading space 118 using loading mechanism(s) 116/214. In one form, it is contemplated that the central computing system 202 may coordinate the transport using a number and variety of loading mechanisms 214, some of which may be more appropriate for certain merchandise items 104 than others. The central computing system 202 may use a variety of types of loading mechanisms 214 in moving merchandise items 104 from the conveyor assemblies 112 to the loading space 118, such as, without limitation, robots or robot arms, automated guided vehicles (AGVs), voice commands, speech recognition, networked interactive eyewear, laser guidance, computer designed loading maps, and/or RFID tags. So, for instance, robots and robotic arms may be used for lifting and moving heavier merchandise items 104; AGVs with storage areas may be locally or remotely navigated to move appropriately sized merchandise items 104 to the loading space 118; voice commands and speech recognition may be used to direct robots or AGVs and/or for employee communication with the central computing system 202; networked interactive eyewear (such as Google glasses) and/or laser guidance (i.e., a laser spotlight) may be used to direct employees as to which merchandise items to load into the loading space 118 next and in which location; computer designed loading maps may be used to show the sequence of loading and arrangement of merchandise items 104 in the loading space 118 (which maps may be displayed in various ways, such as on handheld mobile devices, personal computers, networked interactive eyewear and other wearable technology, etc.); and RFID tags may assist in identifying the merchandise items 104 to be loaded. It is also contemplated that the system 100 may use other loading tools such as dedicated compartments in the delivery vehicle 106 (frozen compartments for receiving and storing frozen items), artificial intelligence (virtual reality and/or augmented reality), and visual and sound alerts.

In one form, it is contemplated that this coordination of transport may also involve inputting merchandise items 104 that cannot be placed on the conveyor assemblies 112 (non-conveyable freight), which may require manual delivery by an employee to the loading area 110. In other words, for some merchandise items 104, it may be necessary to employ manual delivery of the merchandise items 104 from the loading area 110 to the loading space 118. Conveyed transport may not be appropriate because the merchandise items 104 are too big, too heavy, irregularly shaped, etc., such that manual delivery will be required. In one form, an employee may use a handheld scanner/reader to input a product identifier of the merchandise item 104. In another form, a sensor at or about conveyor assembly 112 may transmit a product identifier to the central computing system 202, which may, in turn, indicate that the merchandise item 104 is non-conveyable freight. It is generally contemplated that the central computing system 202 may communicate with employees equipped with a variety of electronic devices, such as smartphones and other handheld mobile devices, personal computers, wearable technology, etc.

The central computing systems 202 may also receive additional inputs, i.e., additional signals, that it may take into account in determining the arrangement of merchandise items 104 in the loading space 118 and the sequence of loading. The central computing system 202 may receive a third signal 216 regarding the spatial arrangement of the conveyor assemblies 112 in the merchandise loading area 110. In one form, the central computing system 202 may take into account the positions of the conveyor assemblies 112 in directing loading mechanisms 214 (such as robots or AGVs) to retrieve merchandise items 104 and navigate to the loading space 118. Also, the central computing system 202 may consider the distance of a conveyor assembly 112 from the loading space 118 in determining what merchandise item 104 should be loaded next, i.e., a closer merchandise item 104 might be loaded before a more distant one. In one form, it is contemplated that this spatial arrangement may be communicated at an initial stage (prior to placing merchandise items 104 on conveyor assemblies 112), such as when the conveyor assemblies 112 are arranged or when it is determined which conveyor assemblies 112 in the merchandise loading area 110 are to be used to load a specific delivery vehicle 106.

The central computing system 202 may receive a fourth signal 218 regarding the number and order of delivery destinations of the delivery vehicle 106. For example, the delivery vehicle 106 may be assigned multiple deliveries at various retail stores that will be made in a certain order. In this example, it may be desirable to load the merchandise items 104 on a first-in-first-out basis. In other words, it may be desirable to load the vehicle last with the merchandise items 104 that will be removed at the first retail store (and first loading the delivery vehicle 106 with merchandise items 104 to be delivered to the last retail store). In one form, it is contemplated that the number and order of delivery destinations (and the merchandise items to be delivered to each store) will be known at or prior to loading and will be communicated to or accessible by the central computing system 202. Based on this information, the central computing system 202 may determine the arrangement and sequence of loading of the plurality of merchandise items 104 in the loading space 118 based, at least in part, on the number and order of delivery destinations of the delivery vehicle 106.

The central computing system 202 may receive a fifth signal 220 regarding the scheduled time of departure of the delivery vehicle 106. It may use this information to determine the amount of labor required for loading the delivery vehicle 106 within the time interval prior to departure. In other words, the central computing system 202 may determine the number of employees required for loading the merchandise items 104 in the loading space 118 before the scheduled time of departure of the delivery vehicle 106. In making this determination, the central computing system 202 may also consider the number and types of loading mechanisms 214 available for loading. Based on this determination, it may instruct an increase or decrease in the number of employees assigned to loading in order to satisfy this schedule.

The central computing system 202 may receive a sixth signal 222 that includes feedback information regarding prior deliveries. In other words, the optimized arrangement may consider feedback information (such as past problems and failures) from prior deliveries. As one example, a prior delivery may have positioned fragile merchandise items 104 adjacent other relatively heavy and unstable merchandise items 104 that damaged the fragile merchandise 104. The central computing system 202 may use this feedback information in future deliveries to arrange such fragile items at certain positions in the loading space 118 and/or next to certain types of merchandise items 104. Accordingly, the central computing system 202 may adjust the arrangement and instruction of the sequence of loading of the merchandise items 104 based, at least in part, on the feedback information.

The central computing system 202 receives the first and second signals 210 and 212 (and possibly the other signals 216-22) and takes certain action/output 224, including determining the arrival and location of merchandise items 104 on conveyor assemblies 112, coordinating the transport of merchandise items 104 using loading mechanisms 214, and determining an arrangement and instructing a sequence of loading the merchandise items 104 in the loading space 118. This arrangement is designed to fit the merchandise items 104 in the loading space 118 in a manner such that insufficient volume of the loading space 118 is available for loading additional merchandise items 104. In other words, the loading of the loading space 118 is optimized. In one form, it is contemplated that the loading sequence may be determined prior to removal of merchandise items 104 from the conveyor assemblies 112. In this form, the central computing system 202 may determine the loading sequence prior to removal of the merchandise items 104 and may instruct employees to load the loading space 118 in accordance with the loading sequence.

In summary, in one form, the system 200 is directed generally to end-to-end optimization of loading products/merchandise items 104 onto delivery vehicles 106. The merchandise items 104 may be assembled at various locations of a product/merchandise distribution center 102, loaded onto multiple conveyor assemblies 112, and directed to a loading area 110. This approach considers the entire end-to-end processing leading up to and including loading of the delivery vehicle 106. A central computing system 202 may take into account a number of factors to determine optimal loading: (1) product characteristics (weight, volume, stability, on pallets, boxed/non-boxed, type of product (perishable), etc.); (2) characteristics of the loading space 118 (interior of the delivery vehicle 106—weight distribution, capacity, etc.); (3) a variety of mechanisms 214 for loading the products (robot arms, voice commands, RFID tags, etc.) (4) how products are arriving on the conveyor assemblies 112 (some products cannot be conveyed and need to be manually delivered to the loading area 110) and the spatial arrangement of the multiple conveyor assemblies 112 in the limited loading area 110; (5) the order/sequence of unloading of products at multiple destination stops (i.e., accessibility of products to be unloaded at first stops); (6) labor characteristics (predicting the labor required and available at loading, including using time interval for loading and vehicle departure time); and (7) feedback characteristics (failures/issues that have arisen during prior deliveries). While the merchandise items 104 are moving on the conveyor assemblies 112, the central computing system 202 may determine a loading sequence for certain merchandise items 104 and may instruct the loaders, who then pack the delivery vehicle 106 per the loading sequence.

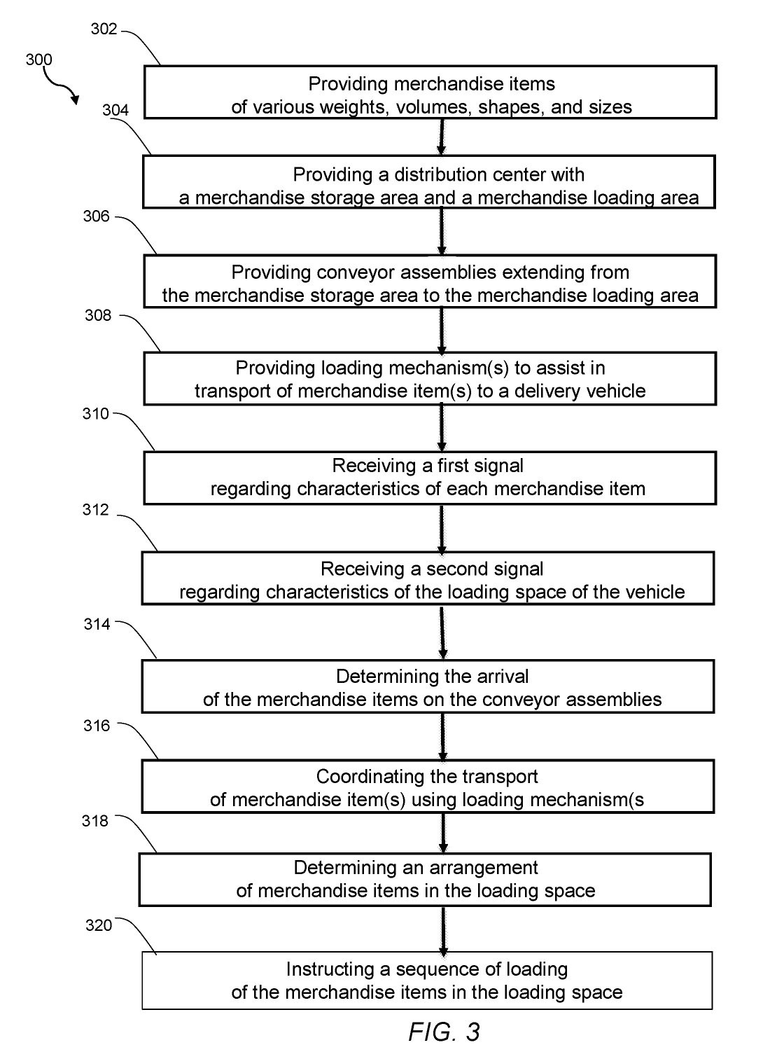

Referring to FIG. 3, there is shown a process 300 for optimizing how merchandise is loaded on delivery vehicles at a merchandise distribution center. The process 300 may use some or all of the components of systems 100 and 200 described above. The process 300 uses various inputs to optimize the loading of merchandise for transport from the distribution center.

Initially, the process 300 involves providing a distribution center that stores merchandise and includes various areas and equipment. At block 302, merchandise items are provided of various weights, volumes, shapes, and sizes. These merchandise items are stored at the distribution center until transported to retail stores or other destinations. At block 304, a distribution center is provided with a merchandise storage area and a merchandise loading area. At block 306, conveyor assemblies are provided extending from the merchandise storage area to the merchandise loading area. At block 308, loading mechanisms are provided to assist in the transport of merchandise items to a delivery vehicle. More specifically, they assist in the transport of merchandise items to a loading space in the delivery vehicle.

At block 310, a first signal is received regarding characteristics of each merchandise item. In one form, without limitation, it is contemplated that a sensor in the merchandise storage area or on or about a conveyor assembly may scan/read a product identifier on the merchandise item (such as a barcode or RFID tag). A central computing system may then access a product identifier database to determine one or more characteristics of the merchandise item (such as weight, volume, dimensions, stability, fragility, whether the merchandise item is to be carried on a pallet, the boxed or unboxed nature of the merchandise item, and/or the perishable nature of the merchandise). In another form, this product identifier might be manually inputted by an employee. Alternatively, without limitation, a sensor in the merchandise storage area or on or about a conveyor assembly may directly measure certain characteristics of the merchandise item, such as weight and/or dimensions.

At block 312, a second signal is received regarding characteristics of the loading space in the delivery vehicle. This step can be accomplished in in a variety of ways. In one form, without limitation, it is contemplated that the delivery vehicle may have a vehicle identifier that may be scanned/read or may be manually entered. A central computing system may then access a vehicle identifier database to determine one or more characteristics of the loading space, such as the dimensions, weight distribution, and/or capacity of the loading space. Alternatively, a sensor (such as an image capture device) may be used to measure or estimate some characteristics of the loading space.

At block 314, the arrival and location of merchandise items on the conveyor assemblies is determined. Sensors (such as photo sensors) mounted on or about the conveyor assemblies may be used to determine the arrival and location. Further, in one form, such sensors may be structurally combined with sensors that read/scan product identifiers to determine characteristics of a merchandise item.

At block 316, the transport of merchandise items from the conveyor assemblies to the loading space is coordinated. For example, a central computing system may determine and instruct a loading mechanism appropriate for transporting a particular merchandise item to the loading space. These loading mechanisms may include, without limitation: robots, robot arms, automated guided vehicles, voice commands, speech recognition, networked interactive eyewear, laser guidance, computer designed loading maps, and RFID tags. In one form, the central computing system may consider characteristics of the merchandise item (such as weight and size) to determine an appropriate loading mechanism for that particular merchandise item.

At block 318, an arrangement of merchandise items in the loading space is determined. In one form, a central computing system considers characteristics of merchandise item(s) and characteristics of the loading space, at least in part, to determine an arrangement. In this form, the central computing system does not necessarily determine the complete arrangement of merchandise items in the loading space at one time, but may instead determine this arrangement on a piecemeal basis as it receives input/signals regarding additional merchandise items being added to the loading space. The arrangement is designed to fit the merchandise items in the loading space in a manner such that insufficient volume of the loading space is available for loading additional merchandise items.

At block 320, a sequence of loading the merchandise items in the loading space is instructed. In one form, a central computing system may work with one or more loading mechanisms to retrieve merchandise items from the conveyor assemblies for loading in a specific order. Again, the central computing system does not necessarily determine the complete sequence of loading of merchandise items in the loading space at one time, but may instead determine parts of sequences on a piecemeal basis as it receives input/signals regarding additional merchandise items to be added to the loading space. In other words, the step of determining a loading sequence may refer to determining the loading sequence of some merchandise items, not necessarily all of the merchandise items to be loaded on the delivery vehicle.

Optionally, the process 300 may include additional inputs/signals that may be considered when determining the arrangement of merchandise items in the loading space, the sequence of loading them in the loading space, and/or the number of employees required to assist with the loading. For example, the process 300 may include one of more of the following: receiving a signal/input regarding the spatial arrangement of the conveyor assemblies in the merchandise loading area; receiving a signal/input regarding the number and order of delivery destinations of the delivery vehicle; receiving a signal/input regarding the scheduled time of departure of the delivery vehicle; and/or receiving a signal/input including feedback information regarding prior deliveries.

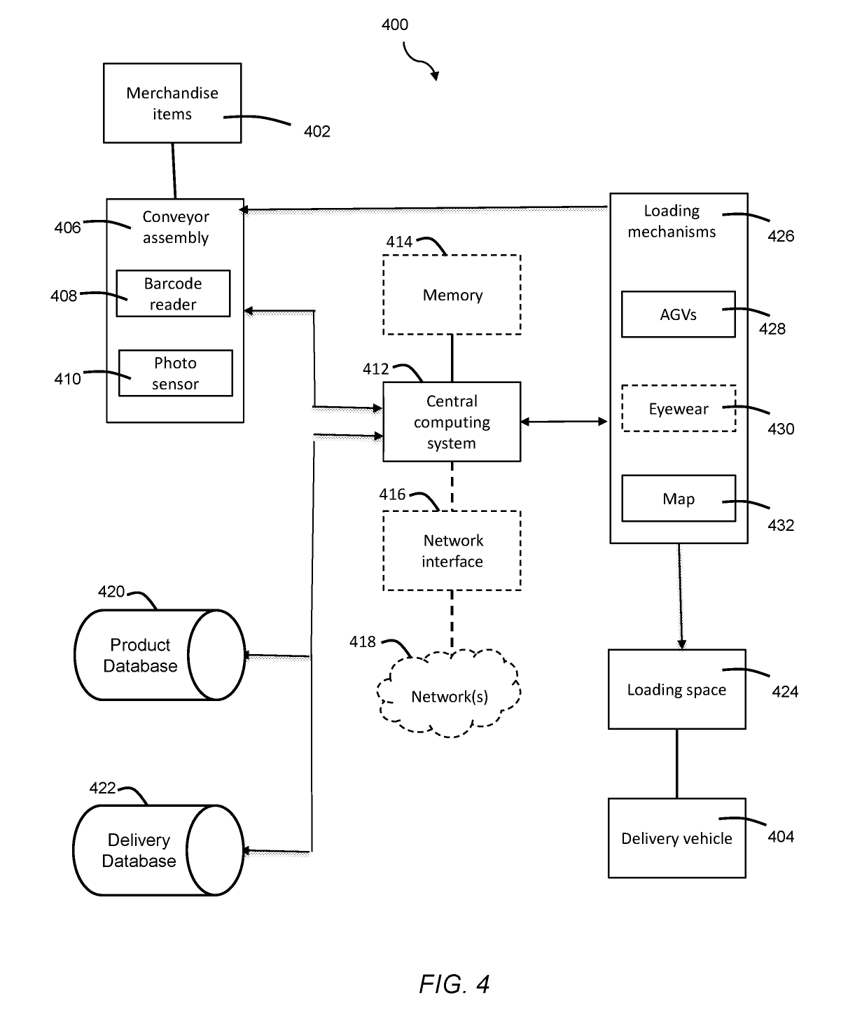

FIG. 4 shows one specific example of a system 400 for optimizing how merchandise items are loaded on delivery vehicles at merchandise distribution center. The system 400 uses some of the components from systems 100 and 200 described above and may be performed in accordance with some or all of the steps of process 300. As can be seen, the system 400 uses inputs from sensors and databases to determine the loading of merchandise items by loading mechanisms and the arrangement of merchandise items in a loading space.

In this form, the system 400 includes merchandise items 402 that are initially retrieved from the storage area of a distribution center. The merchandise items 402 are intended to be included for loading onto a delivery vehicle 404, which may make one or more deliveries to retail stores or other locations. The system 400 also includes conveyor assemblies 406, and the merchandise items 402 are moved from the storage area to the conveyor assemblies 406 and disposed on the conveyor assemblies 406.

In this form, the conveyor assemblies 406 include a barcode reader 408 and a photo sensor 410. The barcode reader 408 reads barcodes on the merchandise items 402 and transmits the barcode to a central computing system 412. The photo sensor 410 detects the arrival and location of merchandise items 402 and transmits this information to the central computing system 412.

The central computing system 412 is generally similar in structure to and operates in the manner described above with respect to central computing system 202. The description of central computing system 202 is incorporated herein. Further, the central computing system 412 may be operably coupled to a memory 414 and to a network interface 416. The network interface 416 is, in turn, coupled to network or networks 418. It is contemplated that the memory 414, network interface 416, and network(s) 418 are similar to and operate in generally the same manner as memory 204, network interface 206, and network(s) 208. Accordingly, the descriptions of memory 204, network interface 206, and network(s) 208 are incorporated herein and not repeated.

In this form, the central computing system 412 is communicatively coupled to a product database 420 and a delivery database 422. It is contemplated that the product database 420 includes data about specific merchandise items 402, including, without limitation, barcodes and dimensions of the merchandise items 402. In this form, the central computing system 412 accesses the product database 420 and looks up the identity of a merchandise item 402 based on the barcode read by the barcode reader 408. Once the identity of the merchandise item 402 is determined, the central computing system 400 also determines the corresponding dimensions of the merchandise item 402. It is also contemplated that the delivery database 422 includes data about the specific delivery to be made, including, without limitation, the dimensions of the loading space 424 of the delivery vehicle 404, the number and order of delivery destinations, merchandise items 402 to be included on the delivery vehicle 404, and the scheduled departure time of the vehicle 404.

As the arrival and location of merchandise items 402 at the conveyor assemblies 406 is detected, the central computing system 412 communicates with loading mechanisms 426 to transport merchandise items 402 to the loading space 424. In this example, it is contemplated that one type of loading mechanism 426 used is an AGV 428. The central computing system 412 communicates with an AGV 428 to retrieve merchandise items 402, directs it to the particular conveyor assembly 406, and then directs it to the loading space 424. In this example, the spatial arrangement and positions of the conveyor assemblies 406 have been previously communicated to the central computing system 402, and the central computing system 412 may communicate with the AGV 428 to navigate it to the loading space 424. This conveyor assembly and AGV positioning and navigation may be performed by any of various navigation and positioning techniques, such as, without limitation, GPS or ultra-wide broadband.

Other types of loading mechanisms 426 used in this example are networked interactive eyewear 430 and a computer designed loading map 432. In this example, an employee at each conveyor assembly 406 and at the loading space 424 may be equipped with eyewear 430 for receiving instructions from the central computing system 412 and for the display of a loading map 432. As an alternative to the eyewear 430, the central computing system 412 may instead communicate with employees equipped with handheld mobile devices or other electronic devices (and display the map 432 on such devices). The employees at the conveyor assemblies 406 may load the AGVs 428 with merchandise items 402 in a certain sequential order. The employee(s) at the loading space 424 may receive the merchandise items 402 from the AGVs 428 and may deposit the items 402 in the loading space 424 in accordance with the arrangement and sequence shown by the map 432.

When an AGV 428 or an employee has deposited a merchandise item 402 in a position in the loading space 424, this deposit is communicated back to the central computing system 412 so that the central computing system 412 has real time information regarding the condition of the loading space 424. This information may be communicated to the central computing system 412 by any of a variety of sensors, such as an image capture device on the AGV 428 (camera/video apparatus, etc.), from images transmitted by the networked interactive eyewear 430, or by manual entry on a handheld mobile device or other electronic device. It is contemplated that this map 432 is continually being updated as the arrival of new merchandise items 402 is detected. The system 400 continues in this manner until loading is completed.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system of end-to-end optimization for the loading of delivery vehicles with merchandise items from merchandise distribution centers, the system comprising:
a plurality of merchandise items of various weights, volumes, shapes, and sizes;
a merchandise distribution center including a merchandise storage area and a merchandise loading area;
a plurality of conveyor assemblies extending from the merchandise storage area to the merchandise loading area, the plurality of conveyor assemblies configured to transport the plurality of merchandise items from the merchandise storage area to the merchandise loading area;
at least one sensor mounted to each conveyor assembly, the at least one sensor configured to detect each merchandise item deposited on the conveyor assembly and to read a product identifier on each merchandise item;
at least one loading mechanism in the merchandise loading area configured to assist in transport of at least one merchandise item from at least one conveyor assembly to a delivery vehicle with an interior defining a loading space, the at least one loading mechanism comprising at least one of a robot or robot arm, automated guided vehicles, voice commands, speech recognition, networked interactive eyewear, laser guidance, a computer designed loading map, and RFID tags;
a central computing system operatively coupled to the plurality of conveyor assemblies and communicatively coupled to the sensors, the central computing system configured to:
receive a first signal regarding characteristics of each merchandise item from the at least one sensor;
receive a second signal regarding characteristics of the loading space;
determine the arrival of the plurality of merchandise items on the plurality of conveyor assemblies in the merchandise loading area based on the first signal from the at least one sensor;
coordinate the transport of at least one subset of merchandise items from the at least one conveyor assembly to the loading space using the at least one loading mechanism; and
determine a first arrangement and instruct a sequence of loading of the plurality of merchandise items in the loading space;
wherein the first arrangement is designed to fit the plurality of merchandise items in the loading space in a manner such that insufficient volume of the loading space is available for loading additional merchandise items.

2. The system of claim 1, wherein the first signal regarding characteristics of each merchandise item comprises data regarding at least one of weight, volume, dimensions, stability, fragility, whether the merchandise item is to be carried on a pallet, the boxed or unboxed nature of the merchandise item, and the perishable nature of the merchandise.

3. The system of claim 1, wherein the second signal regarding characteristics of the loading space comprises data regarding at least one of dimensions, weight distribution, or capacity of the loading space.

4. The system of claim 1, wherein the central computing system is configured to instruct manual delivery of a merchandise item from the loading area to the loading space based, at least in part, on the first signal regarding characteristics of the merchandise item.

5. The system of claim 1, wherein the central computing system is configured to:
receive a third signal regarding the spatial arrangement of the plurality of conveyor assemblies in the merchandise loading area; and
determine the first arrangement and sequence of loading of the plurality of merchandise items in the loading space based, at least in part, on the spatial arrangement of the plurality of conveyor assemblies in the merchandise loading area.

6. The system of claim 1, wherein the central computing system is configured to:
receive a fourth signal regarding the number and order of delivery destinations of the delivery vehicle; and
determine the first arrangement and sequence of loading of the plurality of merchandise items in the loading space based, at least in part, on the number and order of delivery destinations of the delivery vehicle.

7. The system of claim 1, wherein the central computing system is configured to:
receive a fifth signal regarding the scheduled time of departure of the delivery vehicle; and
determine a number of individuals required for loading the plurality of merchandise items in the loading space by the scheduled time of departure of the delivery vehicle.

8. The system of claim 1, wherein the central computing system is configured to:
receive a sixth signal comprising feedback information regarding prior deliveries; and
adjust the determination of the first arrangement and the instruction of the sequence of loading of the plurality of merchandise items based, at least in part, on the feedback information.

9. The system of claim 1, wherein the central computing system is configured to:
determine the loading sequence prior to removal of the plurality of merchandise items from the plurality of conveyor assemblies; and
instruct a predetermined number of individuals to load the loading space in accordance with the loading sequence.

10. A method for loading delivery vehicles with merchandise items from merchandise distribution centers, the method comprising:
providing a plurality of merchandise items of various weights, volumes, shapes, and sizes;
providing a merchandise distribution center including a merchandise storage area and a merchandise loading area;
providing a plurality of conveyor assemblies extending from the merchandise storage area to the merchandise loading area, the plurality of conveyor assemblies configured to transport the plurality of merchandise items from the merchandise storage area to the merchandise loading area;
providing at least one sensor mounted to each conveyor assembly;
detecting each merchandise item deposited on the conveyor assembly and reading a product identifier on each merchandise item;
providing at least one loading mechanism in the merchandise loading area configured to assist in transport of at least one merchandise item from at least one conveyor assembly to a delivery vehicle with an interior defining a loading space, the at least one loading mechanism comprising at least one of a robot or robot arm, automated guided vehicles, voice commands, speech recognition, networked interactive eyewear, laser guidance, a computer designed loading map, and RFID tags;
receiving a first signal regarding characteristics of each merchandise item from the at least one sensor;
receiving a second signal regarding characteristics of the loading space;
determining the arrival of the plurality of merchandise items on the plurality of conveyor assemblies in the merchandise loading area based on the first signal from the at least one sensor;
coordinating the transport of at least one subset of merchandise items from the at least one conveyor assembly to the loading space using the at least one loading mechanism;
determining a first arrangement of the plurality of merchandise items in the loading space; and
instructing a sequence of loading of the plurality of merchandise items in the loading space;
wherein the first arrangement is designed to fit the plurality of merchandise items in the loading space in a manner such that insufficient volume of the loading space is available for loading additional merchandise items.

11. The method of claim 10, further comprising instructing manual delivery of a merchandise item from the loading area to the loading space.

12. The method of claim 10, further comprising:
receiving a third signal regarding the spatial arrangement of the plurality of conveyor assemblies in the merchandise loading area; and
determining the first arrangement and sequence of loading of the plurality of merchandise items in the loading space based, at least in part, on the spatial arrangement of the plurality of conveyor assemblies in the merchandise loading area.

13. The method of claim 10, further comprising:
receiving a fourth signal regarding the number and order of delivery destinations of the delivery vehicle; and
determining the first arrangement and sequence of loading of the plurality of merchandise items in the loading space based, at least in part, on the number and order of delivery destinations of the delivery vehicle.

14. The method of claim 10, further comprising:
receiving a fifth signal regarding the scheduled time of departure of the delivery vehicle; and
determining a number of individuals required for loading the plurality of merchandise items in the loading space by the scheduled time of departure of the delivery vehicle.

15. The method of claim 10, further comprising:
receiving a sixth signal comprising feedback information regarding prior deliveries; and
adjusting the determination of the first arrangement and the instruction of the sequence of loading of the plurality of merchandise items based, at least in part, on the feedback information.

16. The method of claim 10, further comprising:
determining the loading sequence prior to removal of the plurality of merchandise items from the plurality of conveyor assemblies; and
instructing a predetermined number of individuals to load the loading space in accordance with the loading sequence.
